(19) United States
(12) Patent Application Publication
(10) Pub. No.: US 2013/0213575 A1
(43) Pub. Date: Aug. 22, 2013

(54) Atmospheric Pressure Plasma Generating Apparatus

(71) Applicants: Il Wook Kim, Seoul (KR); Chang Duek Choi, Seoul (KR)

(72) Inventors: Il Wook Kim, Seoul (KR); Chang Duek Choi, Seoul (KR)

(21) Appl. No.: 13/680,891

(22) Filed: Nov. 19, 2012

(30) Foreign Application Priority Data
Feb. 17, 2012 (KR) 10-2012-0016577

(51) Int. Cl. H05H 1/46

(52) U.S. Cl. CPC H05H 1/46
USPC 156/345.44; 118/723 E; 315/111.21

(57) ABSTRACT

One embodiment of the present disclosure provides an atmospheric pressure plasma generating apparatus. The apparatus includes an upper electrode having an air permeable inner structure, a lower electrode separated from the upper electrode, and a power source applying voltage to the upper electrode or the lower electrode. The apparatus further includes a plasma generating region placed in a space between the upper electrode and the lower electrode. The upper electrode serves as a passageway using the air permeable inner structure, through which reaction gas is supplied to the plasma generating region from outside.

### CROSS-REFERENCE TO RELATED APPLICATION

This application claims the benefit under 35 U.S.C. §119 of Korean Patent Application No. 10-2012-0016577, filed Feb. 17, 2012, which is hereby incorporated by reference in its entirety.

### BACKGROUND

1. Technical Field

The present disclosure generally relates to a plasma generating apparatus, and more particularly, to an atmospheric pressure plasma generating apparatus which generates plasma at atmospheric pressure for plasma treatment of a substrate.

2. Description of the Related Art

Currently, a plasma-based manufacturing process is widely applied to fabrication of integrated circuits of electric devices, such as semiconductor devices, liquid crystal display (hereinafter, LCD) panels, flat panel display (FPD) panels, and the like. Specifically, energy needed for chemical reaction between a substrate and reaction gas is supplied from plasma in thin film deposition, etching, and cleaning, which are performed to form an integrated circuit.

Electric discharge for generating plasma occurs by applying high voltage between two electrodes formed of an electrical conductive material such as metal. Here, when an electric field generated by high voltage is concentrated on a certain region to locally ionize gas around the region, streamer plasma is generated, and this phenomenon is called corona discharge. If voltage is applied to the two electrodes after significantly decreasing the gap between the two electrodes, arc discharge occurs, generating linear plasma of a very small diameter. Typically, corona discharge is likely to be changed to arc discharge.

Instead of using low pressure plasma, the challenge of recent plasma process techniques is to generate plasma at atmospheric pressure such that the atmospheric pressure plasma can be applied to a manufacturing process. Arc discharge is more likely to occur at a high process pressure than at a low process pressure, and thus it is necessary to prevent transition from corona discharge to arc discharge in order to ensure generation of atmospheric pressure plasma in a stable state. Examples of a method for preventing transition of corona discharge to arc discharge include intermittent application of voltage from a power supply, connection of a resistance to an electrode, use of ceramic electrodes, and the like. Recently, a dielectric capillary disc having a plurality of holes is attached to a lower surface of the electrode to suppress transition from corona discharge to arc discharge.

FIG. 1 is a schematic diagram of a conventional plasma generating apparatus. Referring to FIG. 1, the plasma generating apparatus 100 includes facing upper and lower electrodes 10, 20 separated from each other, and a power supply unit 40 which supplies radio frequency (RF) voltage to the upper electrode 10. The upper electrode 10 is provided at a lower side thereof with a capillary disc 30 having a plurality of through-holes 35 to suppress transition from corona discharge to arc discharge. The through-holes 35 may have a size of several millimeters and may be formed by machining the capillary disc 30. Although not shown in the drawings, reaction gas is introduced through a separate gas supply pipe to generate plasma.

The aforementioned and other conventional methods do not provide satisfactory results in obtaining uniform large area plasma at atmospheric pressure. In addition, plasma generated by the conventional methods has low density, causing deterioration in process efficiency. Further, since high temperature plasma is generated at atmospheric pressure, the lifespan of the electrodes can be shortened due to contact with the high temperature plasma.

### BRIEF SUMMARY

One aspect of the present disclosure is to provide an atmospheric pressure plasma generating apparatus, which may generate large area plasma uniformly dispersed and having high density.

One embodiment of the present disclosure provides an atmospheric pressure plasma generating apparatus, which includes an upper electrode having an air permeable inner structure, a lower electrode separated from the upper electrode, and a power source applying voltage to the upper electrode or the lower electrode. The apparatus further include a plasma generating region placed in a space between the upper electrode and the lower electrode. The upper electrode serves as a passageway using the air permeable inner structure, through which reaction gas is supplied to the plasma generating region from outside.

Another embodiment of the present disclosure provides an atmospheric pressure plasma generating apparatus, which includes a plasma generating region, and a plasma processing region plasma processing region placed at a lower portion of the apparatus near the plasma generating region and receiving a target substrate. Here, the plasma generating region includes an upper electrode formed of an air permeable material, a lower electrode separated from the upper electrode, a power source applying voltage to the upper electrode or the lower electrode, and a process gas supply tube placed above the upper electrode to supply reaction gas into the plasma generating region from outside therethrough.

In the atmospheric pressure plasma generating apparatus according to one embodiment of the present disclosure, an upper electrode connected to a power source comprises a material having an air permeable inner structure, thereby enabling generation of atmospheric pressure plasma uniformly dispersed and having high density. Here, since the upper electrode may further include a dielectric disc having an air permeable structure, it is possible to more efficiently suppress transition of the plasma into discharge arc. As a result, the plasma generating apparatus according to the embodiment may improves plasma process efficiency and enlarge a plasma processing window.

In addition, according to the embodiment, the plasma generating apparatus generates high density plasma at atmospheric pressure, thereby efficiently forming high energy radicals. Thus, the atmospheric pressure plasma may be applied to semiconductor thin film deposition, photosensitive film removal and junction, grinding, cleaning, sterilization, disinfection, ozone production, dyeing, etching, purification of tap water and waste water, purification of air and exhaust gas, fabrication of lighting, and the like.

Further, according to the embodiment, the plasma generating apparatus may efficiently generate atmospheric pressure plasma having high density without arc discharge, thereby increasing the density of reactive radicals. As a result, the reaction speed of the plasma with a substrate is increased, thereby improving the growth rate of a thin film in thin film deposition. Further, the plasma generating apparatus may achieve thin film growth at a lower temperature than conventional techniques.

### BRIEF DESCRIPTION OF THE DRAWINGS

The above and other aspects, features and advantages of the present disclosure will become apparent from the following description of embodiments given in conjunction with the accompanying drawings, in which:

FIG. 1 is a schematic diagram of a conventional plasma generating apparatus;

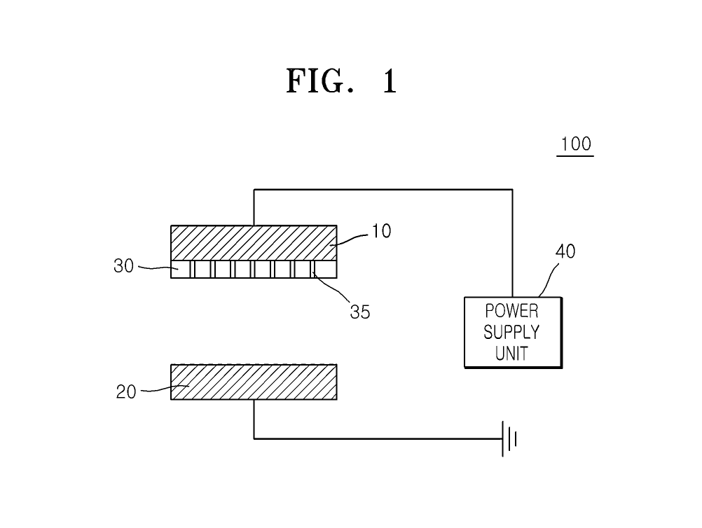

FIG. 2 is a side view of an atmospheric pressure plasma generating apparatus in accordance with one embodiment of the present disclosure;

FIG. 3 is a side view of an atmospheric pressure plasma generating apparatus in accordance with another embodiment of the present disclosure;

FIG. 4 is a side view of an atmospheric pressure plasma generating apparatus in accordance with a further embodiment of the present disclosure;

FIG. 5 is a side view of a plasma generating region of the atmospheric pressure plasma generating apparatus shown in FIG. 4;

FIG. 6 is a side view of an atmospheric pressure plasma generating apparatus in accordance with yet another embodiment of the present disclosure;

FIGS. 7 and 8 are pictures of the microstructure of an upper electrode having an air permeable structure in accordance with one embodiment of the present disclosure; and

FIG. 9 is a graph depicting a state of plasma according to frequency of voltage in an atmospheric pressure plasma generating apparatus in accordance with one embodiment of the present disclosure.

### DETAILED DESCRIPTION

Embodiments of the present disclosure will be described in more detail with reference to the accompanying drawings. It should be understood that the present disclosure is not limited to the following embodiments and may be embodied in different ways, and that the embodiments are given to provide complete disclosure of the application and to provide thorough understanding of the disclosure to those skilled in the art. Further, the widths, thicknesses and other dimensions of components may be exaggerated for clarity. The accompanying drawings are illustrated in view of an observer. Further, it will be understood that when an element is referred to as being “placed” or “disposed” on another element, it can be directly placed or disposed on the another element, it can be separated a predetermined interval from the another element, or a third element may also be present therebetween. Furthermore, it should be understood by those skilled in the art that the techniques of the present disclosure may be embodied in various ways without departing from the scope of the present disclosure. Like components will be denoted by like reference numerals throughout the specification. As used herein, the term “atmospheric pressure” will be used to refer to a pressure ranging from about 500 Ton to about 900 Ton.

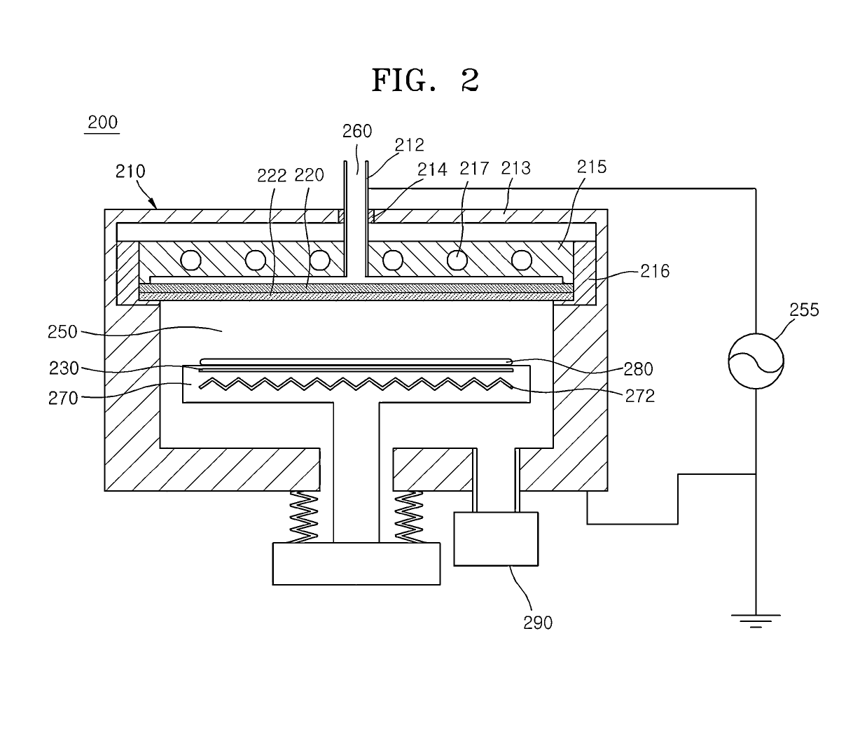

FIG. 2 is a side view of an atmospheric pressure plasma generating apparatus in accordance with one embodiment. Referring to FIG. 2, the atmospheric pressure plasma generating apparatus 200 includes an upper electrode 220, a lower electrode 230 separated from the upper electrode 220, a power source 255 applying voltage to the upper electrode 220 or the lower electrode 230, and a plasma generating region 250 placed in a space between the upper electrode 220 and the lower electrode 230. The upper electrode 220 may be formed of a material having an air permeable inner structure. Specifically, the upper electrode 220 may be formed of a material having a fine air permeable inner structure. The upper electrode 220 acts as a passageway using the air permeable inner structure, through which reaction gas for generating plasma is introduced into the plasma generating region 250 from outside of the atmospheric pressure plasma generating apparatus. To receive the reaction gas from the outside, at least one process gas supply tube 260 may be placed above the upper electrode 220.

Referring to FIG. 2, the atmospheric pressure plasma generating apparatus may be generally divided into a plasma chamber 210 and the power source 255. The plasma chamber 210 may include a first body 213 and a second body 215 electrically insulated from each other by a first insulator 214 and a second insulator 216. The first and second bodies 213, 215 may be formed of an electrically conductive material. The plasma chamber 210 is provided at an upper side thereof with an electrode rod 212 which transfers voltage to the upper electrode when the voltage is applied from the power source 255 to the chamber. The electrode rod 212 adjoins the first insulator 214 placed in the first body 213 of the plasma chamber 210 and is electrically connected to the second body 215. The first body 213 may be connected to ground and the second body 215 may have a potential difference with respect to the first body 213 by the voltage applied from the power source 255. The second body 215 may be formed of metal or metal alloys such as aluminum or aluminum alloys, without being limited thereto. The second body 215 may electrically contact the upper electrode 220 along the circumference of the plasma chamber 210. The second body 215 may be electrically insulated from the first body 213 by the second insulator 216. In one embodiment, a cooler 217 may be placed within the second body 215. As shown in FIG. 2, the process gas supply tube 260 may provide the function of the electrode rod 212. In other embodiments, although not shown in the drawings, the electrode rod 212 may be independent of the process gas supply tube 260. That is, the electrode rod 212 may be additionally disposed in the plasma chamber 200 and electrically connected to the upper electrode 220 within the plasma chamber 210. The upper electrode 220 is placed within the plasma chamber 210. The upper electrode 220 generates plasma together with the lower electrode 230 according to voltage applied from the power source 255. The upper electrode 220 formed of a material having an air permeable inner structure may comprise an electric conductor formed of a porous material. As a result, the reaction gas supplied through the process gas supply tube 260 may be supplied to the plasma generating region 250 through the porous inner structure of the upper electrode 220. The upper electrode 220 may be formed of at least one selected from among, for example, carbon, graphite, copper, and aluminum. The material having the porous inner structure may be obtained by any known process such as electrode position, sintering, and the like.

In some embodiments, the upper electrode 220 may be fabricated by coating the surface of the porous electric conductor with an insulation film. Thus, the upper electrode 220 may include a surface coating layer of the insulation film on the porous electric conductor. For example, the upper electrode 220 may be formed of porous aluminum coated with aluminum oxide.

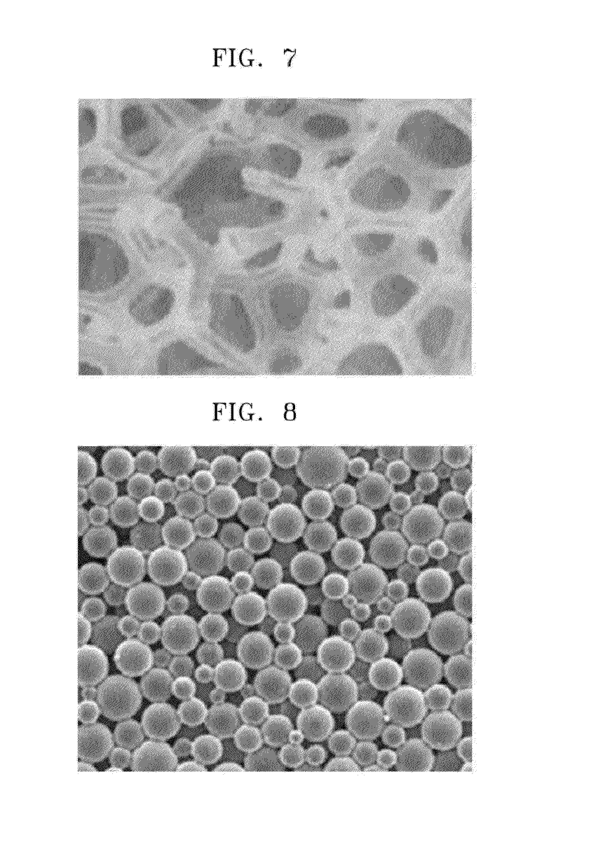

The upper electrode 220 may be formed of an air permeable material having a conductive network structure as in the microstructure of porous aluminum of FIG. 7, or a conductive particle structure as in the microstructure of porous carbon of FIG. 8. The upper electrode 220 allows the reaction gas to pass through the porous inner structure thereof, such that the reaction gas may be supplied to the plasma generating region 250 in a more uniformly spread state. The upper electrode 220 may have, for example, a thickness of 0.01 mm to 100 mm.

In some embodiments, a dielectric disc 222 having an air permeable structure may be placed on a lower surface of the upper electrode 220 adjoining the plasma generating region 250, as shown in FIG. 2. The dielectric disc 222 may be formed of a porous insulating material. The dielectric disc 222 allows the reaction gas to be uniformly spread when the reaction gas is supplied to the plasma generating region 250 through the upper electrode 220. Further, the dielectric disc 222 adjoins the lower surface of the upper electrode 220, thereby preventing arc discharge during generation of plasma. The dielectric disc 222 may comprise at least one selected from, for example, zirconium oxide, alumina, silicon carbide, silicon nitride, and quartz. The dielectric disc 222 may be formed of a material having an air permeable inner structure, for example, an insulating network structure or a grain structure of non-conductive particles. That is, the dielectric disc 222 may be formed of a material having a fine air permeable structure. The dielectric disc 222 may have, for example, a thickness ranging from 0.01 mm to 100 mm. The air permeable inner structure may be obtained by any known process such as electrodeposition, sintering, and the like.

The lower electrode 230 is separated from the upper electrode 220. With the upper electrode 220 connected at one end thereof to the power source 255, the lower electrode 230 may be connected at one end thereof to ground. Although not shown in the drawings, the one end of the lower electrode 230 may be connected to a ground electrode or may be electrically connected to an outer wall of the plasma chamber 210 to be connected to ground. In one embodiment, the lower electrode 230 may be placed within a support structure 270 in the plasma chamber 210, as shown in FIG. 2. The support structure 270 may be configured to move in a vertical direction or rotate within the plasma chamber 210, and may be provided therein with a heater 272. In some embodiments, the lower electrode 230 may also act as a heater. In this case, the lower electrode 230 may maintain the temperature of a substrate 280, for example, in the range from about 100° C. to 800° C., specifically, at 500° C. The substrate 280 may be placed on the support structure 270.

In the plasma generating apparatus 200 according to this embodiment, the reaction gas is introduced into the plasma chamber 210 through the upper electrode 220 and the dielectric disc 222 having the air permeable structure. Then, when voltage is applied from the power source 255 between the upper electrode 220 and the lower electrode 230, a uniform atmospheric pressure plasma with high density is generated in the plasma generating region 250. At this time, the atmospheric pressure plasma produces highly reactive radicals from the reaction gas, and the highly reactive radicals chemically react with the substrate 280, thereby enabling formation of a thin film, cleaning or etching on the substrate 280. In other words, the plasma generating region 250 provides a space not only for generating plasma, but also for processing the substrate 280 using the plasma. The reaction gas may include at least one, selected from the group consisting of vapor (H₂O), oxygen (O₂), nitrogen (N₂), hydrogen (H₂), argon (Ar), helium (H₂), methane (CH₄), ammonia (NH₃), carbon fluoride (CF₄), acetylene (C₂H₂), propane (C₃H₈), silane (SiH₄), disilane (Si₂H₆), dichlorosilane (DCS, SiH₂Cl₂), neo penta silane (NPS), trimethyl aluminum (TMA), bis(tertiary-butylamino) silane (BTBAS), bis(diethylamino) silane (BDEAS), tris(dimethylamino) silane (TDMAS), hexamethyldisiloxane (HMDSO), tetramethylcyclotetra-siloxane (TMCTS), tetraethylorthosilicate (TEOS), hexamethyldisilazane (HMDSN), and tetramethyldisiloxane (TMDSO), without being limited thereto. After reaction, the radicals may be discharged together with byproduct gas from the plasma chamber 210 through an exhaust port 290.

The power source 255 may apply voltage, for example, in the form of unipolar pulses or bipolar pulses. The power source 255 may apply RF voltage, for example, in the range from 1 MHz to 500 MHz. The power source 255 may apply power, for example, in the range from 100 W to 40,000 W, specifically, a power of 10,000 W, to generate plasma.

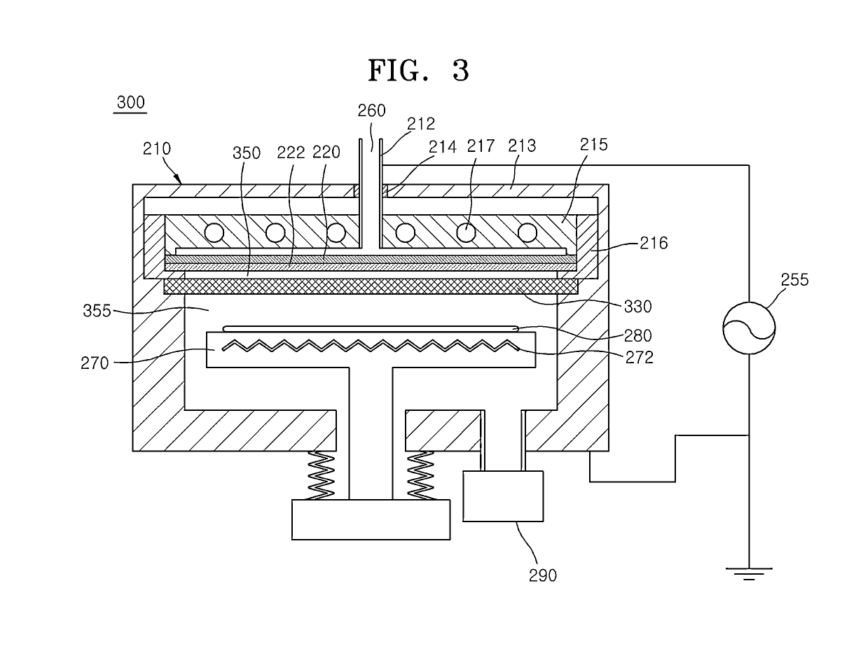

FIG. 3 is a side view of an atmospheric pressure plasma generating apparatus in accordance with another embodiment. Referring to FIG. 3, the apparatus 300 according to this embodiment includes an upper electrode 220, a lower electrode 330 separated from the upper electrode 220, a power source 255 applying voltage to the upper electrode 220 and the lower electrode 230, and a plasma generating region 350 placed in a space between the upper electrode 220 and the lower electrode 330. The upper electrode 220 may be formed of a material having an air permeable inner structure. Specifically, the upper electrode 220 may be formed of a material having a fine air permeable inner structure. The upper electrode 220 acts as a passageway using the air permeable inner structure, through which reaction gas for generating plasma is introduced into the plasma generating region 350 from outside of the apparatus 300. In some embodiments, a dielectric disc 222 formed of a material having an air permeable structure may be placed on a lower surface of the upper electrode 220 adjoining the plasma generating region 350, as shown in FIG. 3.

The atmospheric pressure plasma generating apparatus 300 shown in FIG. 3 has substantially the same structure as that of the atmospheric pressure plasma generating apparatus 200 of FIG. 2, except for the material, structure, and arrangement of the lower electrode 330. Thus, repeated descriptions of the same components will be omitted for clarity.

Referring to FIG. 3, the lower electrode 330 may be placed above the substrate 280. With this arrangement, the interior of the plasma chamber 210 may be divided into the plasma generating region 350 in which plasma is generated using voltage and reaction gas, and a plasma processing region 355 in which the substrate is processed using the plasma. As shown in FIG. 3, the lower electrode 330 may be electrically connected to the first body 213 and thus connected to ground.

In the plasma generating apparatus 300 according to this embodiment, the reaction gas is supplied through the process gas supply tube 260, and atmospheric pressure plasma may be generated in the plasma generating region 350 when voltage is applied from the power source 255 between the upper electrode 220 and the lower electrode 330. The lower electrode 330 may comprise at least one selected from among, for example, carbon, graphite, copper, and aluminum. In some embodiments, the lower electrode 330 may be fabricated by coating the surface of the porous electric conductor with an insulation film. By way of example, the lower electrode 330 may be formed of porous aluminum coated with aluminum oxide. The lower electrode 330 may be formed of the air permeable material having a conductive network structure as in the inner structure of porous aluminum of FIG. 7, or a grain structure of conductive particles as in the inner structure of porous carbon of FIG. 8.

The lower electrode 330 allows reactive radicals of plasma generated within the plasma generating region 350 to pass through the porous inner structure thereof, such that the reaction gas may be supplied to the plasma processing region 355 in a more uniformly spread state. The lower electrode 330 may have, for example, a thickness of 0.01 mm to 100 mm.

In the plasma processing region 355, the reactive radicals reach the substrate 280, thereby enabling formation of a thin film, cleaning or etching on the substrate 280. After reaction, the radicals may be discharged together with byproduct gas from the plasma chamber 210 through the exhaust port 290.

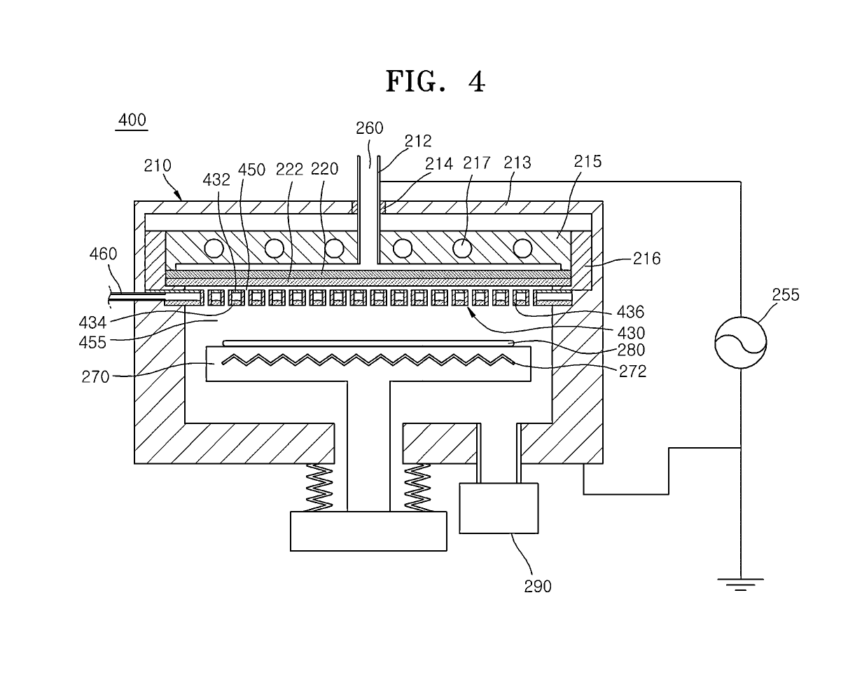

FIG. 4 is a side view of an atmospheric pressure plasma generating apparatus in accordance with a further embodiment. Referring to FIG. 4, the atmospheric pressure plasma generating apparatus 400 according to this embodiment includes an upper electrode 220, a lower electrode 430 separated from the upper electrode 220, a power source 255 applying voltage to the upper electrode 220 and the lower electrode 430, and a plasma generating region 450 placed in a space between the upper electrode 220 and the lower electrode 430. Further, the plasma generating apparatus 400 includes a plasma processing region 455 between the plasma generating region 450 and the substrate 280. The upper electrode 220 may be formed of a material having an air permeable inner structure. The upper electrode 220 acts as a passageway using the air permeable inner structure, through which reaction gas for generating plasma is introduced from outside of the apparatus 400 into the plasma generating region 350. In some embodiments, a dielectric disc 222 formed of a material having an air permeable structure may be placed on the lower surface of the upper electrode 220 adjoining the plasma generating region 450, as shown in FIG. 4.

The atmospheric pressure plasma generating apparatus 400 shown in FIG. 4 has substantially the same structure as that of the atmospheric pressure plasma generating apparatus 200 of FIG. 2, except for the material, structure, and arrangement of the lower electrode 430. Thus, repeated descriptions of the same components will be omitted for clarity.

Referring to FIG. 4, the lower electrode 430 may be placed above the substrate 280. With this arrangement, the interior of the plasma chamber 210 may be divided into the plasma generating region 450 in which plasma is generated using voltage and reaction gas, and a plasma processing region 455 in which the substrate 280 is processed using the plasma.

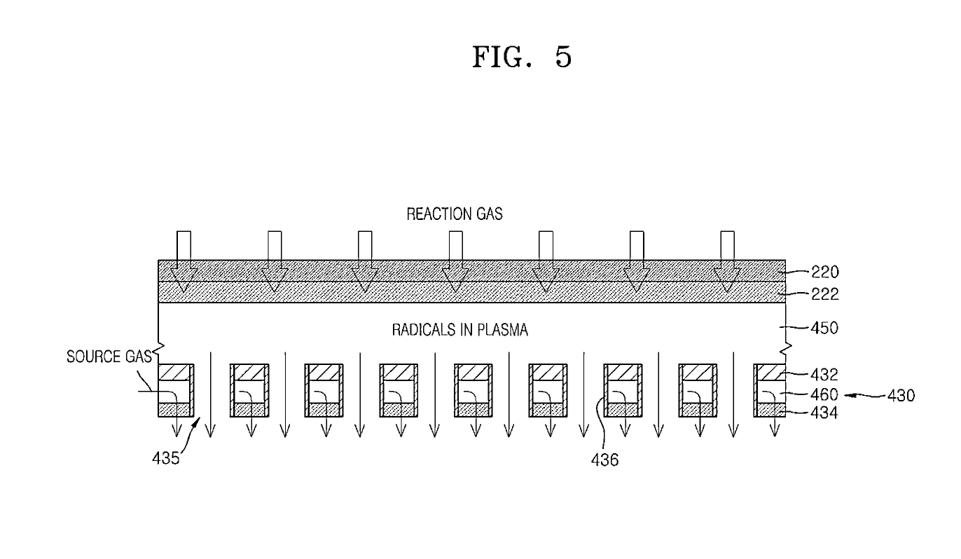

FIG. 5 is a side view of the plasma generating region of the atmospheric pressure plasma generating apparatus shown in FIG. 4. Referring to FIG. 5, the lower electrode 430 includes a conduction plate 432 having plural first through-holes 433 and a spreading plate 434 having plural second through-holes 435 corresponding to the first through-holes 433. The spreading plate 434 is separated from the conduction plate 432 to face each other. The first and second through-holes 433, 435 are formed in a penetration pipe 436. A source gas for processing the substrate 280 is supplied into a space between the conduction plate 432 and the spreading plate 434 from outside of the atmospheric pressure plasma generating apparatus and through a gas supply tube 460. The conduction plate 432 may be formed of metal or alloys, for example, aluminum, aluminum alloys, and the like. The spreading plate 434 may be formed of a material having an air permeable inner structure, for example, a porous conductive material or a porous insulating material. The penetration pipe 436 may be formed of various materials, such as metal, alloys, ceramic, polymers, and the like.

Referring to FIG. 4 and FIG. 5, reactive radicals of plasma generated in the plasma generating region 450 between the upper electrode 220 and the conduction plate 432 of the lower electrode 430 are introduced into the plasma processing region 455 through the penetration pipe 436. The gas supply tube 460 independent of the process gas supply tube 260 and placed on a sidewall of the plasma chamber 210 is provided to supply the source gas for processing the substrate 280. The source gas is supplied to the plasma processing region 455 without passing through the plasma generating region 450. In other words, the source gas flowing into a space between the conduction plate 432 and the spreading plate 434 through the gas supply tube 460 may be introduced into the plasma processing region 455 through the spreading plate 434 of the air permeable inner structure. As a result, the source gas may reach the plasma processing region 455 without being mixed with the reactive radicals introduced through the penetration pipe 436.

The source gas may be, for example, inert gas, silane (SiH₄) gas, and the like. The inert gas may include, for example, helium (He), argon (Ar), or nitrogen (N₂), which may be used alone or in combination thereof. In order to form a silicon epitaxial layer on the wafer substrate in the plasma processing region 455, the source gas may contain helium and silane (SiH₄). In one embodiment, for growth of an epitaxial layer on the wafer substrate subjected to surface treatment, helium may be supplied as an inert gas, for example, at a flux ranging from about 1 slm to about 100 slm, hydrogen (H₂) may be supplied as a reaction gas, for example, at a flux ranging from about 1 sccm to about 100 sccm, and silane (SiH₄) gas may be supplied as a source gas, for example, at a flux ranging from about 1 sccm to about 100 sccm.

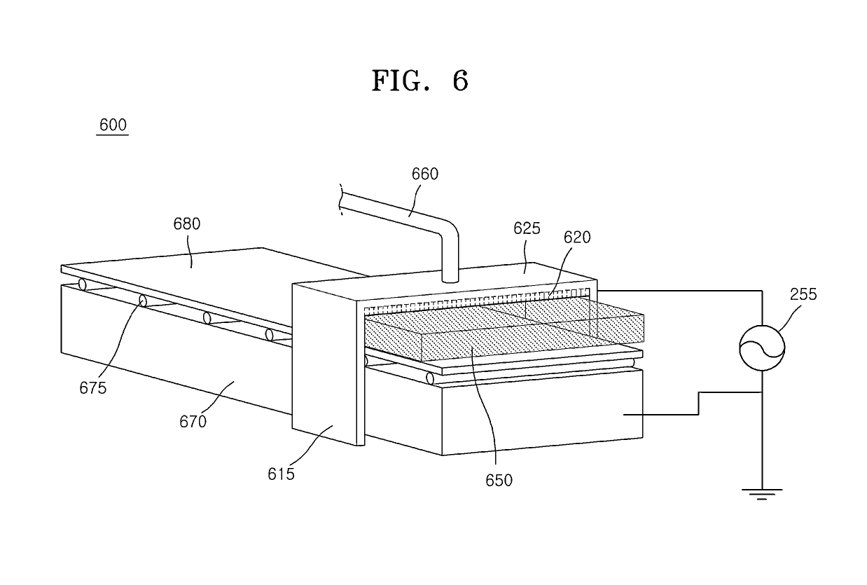

FIG. 6 is a side view of an atmospheric pressure plasma generating apparatus in accordance with yet another embodiment. Referring to FIG. 6, the atmospheric pressure plasma generating apparatus 600 according to this embodiment includes an upper electrode 620, a lower electrode 670 separated from the upper electrode 620, a power source 255 applying voltage to the upper electrode 620 and the lower electrode 670, and a plasma generating region 650 placed in a space between the upper electrode 620 and the lower electrode 670. The upper electrode 620 may be formed of a material having an air permeable inner structure. The upper electrode 620 may be defined by a case 625, which is provided at one side thereof with a process gas supply tube 660. The upper electrode 620 acts as a passageway using the air permeable inner structure, through which reaction gas supplied from the process gas supply tube 660 is introduced into the plasma generating region 650.

Referring to FIG. 6, the substrate 680 is transferred by substrate transfer members 675, such as rollers, to sequentially pass through the plasma generating region 650. When the substrate 680 passes through the plasma generating region 650, highly reactive radicals are produced by plasma in the plasma generating region 650 and chemically react with the substrate 680, thereby enabling formation of a thin film, cleaning or etching on the substrate 680. Referring to FIG. 6, the lower electrode 670 is placed in a direction of moving the substrate 680 so as to act as a support plate for the substrate. The lower electrode 670 may be connected to ground. Alternatively, the lower electrode 670 may be separately disposed below the substrate 280 over an area corresponding to the upper electrode 620. As shown in the figure, a holding member 615 may be provided to hold the upper electrode 620.

FIGS. 7 and 8 are images of the microstructure of an upper electrode having an air permeable structure in accordance with one embodiment of the present disclosure. Specifically,

FIG. 7 is an image of the porous inner structure of aluminum and FIG. 8 is an image of the porous inner structure of carbon. That is, FIG. 7 shows that the porous inner structure of aluminum has a network shape and FIG. 8 shows that the porous inner structure of carbon has an aggregate shape of particles. As shown in FIGS. 7 and 8, when the upper electrode is an electric conductor having a porous structure, the gas may pass through the upper electrode while uniformly spreading therein.

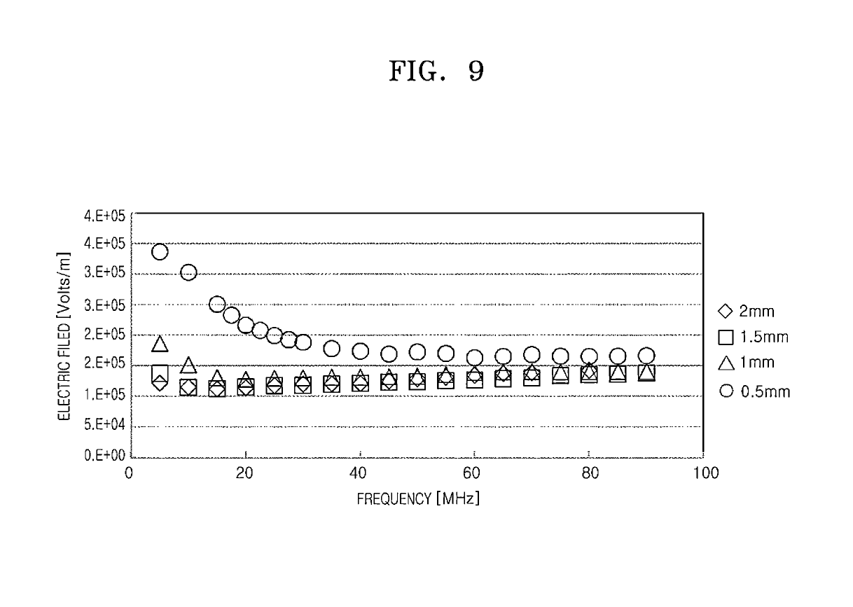

FIG. 9 is a graph depicting a state of plasma according to frequency of voltage in an atmospheric pressure plasma generating apparatus in accordance with one embodiment of the present disclosure. The test results of FIG. 9 were obtained by measuring an electric field in plasma according to frequency bands applied to the upper and lower electrodes of the plasma generating apparatus described with reference to FIG. 2, while changing the distance between the upper electrode and the lower electrode. Referring to FIG. 9, plasma exhibited stable electric field characteristics when the distance between the upper electrode and the lower electrode was in the range from 0.05 mm to 2 mm. In particular, when the distance between the upper and lower electrodes was 1 mm or more, a uniform electric field was obtained irrespective of frequency band.

As described above, in the atmospheric pressure plasma generating apparatus according to the embodiment, the upper electrode connected to the power source may comprise a material having an air permeable inner structure. Accordingly, the plasma generating apparatus may provide uniform atmospheric pressure plasma having high density. At this time, the dielectric disc having an air permeable structure may be attached to the upper electrode, thereby preventing arc discharge upon generation of plasma. As a result, it is possible to improve plasma processing efficiency while enlarging a plasma processing window.

Further, according to the embodiment, the plasma generating apparatus generates high density plasma at atmospheric pressure, thereby enabling efficient generation of high energy radicals. As a result, the atmospheric pressure plasma may be advantageously applied to semiconductor thin film deposition, photosensitive film removal, junction formation, grinding, cleaning, sterilization, disinfection, ozone production, dyeing, etching, purification of tap water and waste water, purification of air and exhaust gas, fabrication of lighting, and the like .

In some embodiments, the atmospheric pressure plasma apparatus may be used as a dry cleaning apparatus. Specifically, while hydrogen and inert gases (for example, He) are introduced through the process gas supply tube 260, plasma may be generated at atmospheric pressure within the plasma generation region 250, 350 or 450. The atmospheric pressure plasma contains large amounts of hydrogen radicals (H*), which exhibit very high reactivity with a natural oxide film, so that the hydrogen radicals (H*) react with the natural oxide film on the substrate 280, thereby performing dry cleaning.

In other embodiments, the atmospheric pressure plasma apparatus may be used as a thin film deposition apparatus. As shown in FIG. 4, independent of the hydrogen and inert gas introduced into the plasma processing region 455 through the process gas supply tube 260, silane (SiH₄) gas may also be supplied to the plasma processing region 455 through the spreading plate 434 of the air permeable structure via the gas supply tube 460. At this time, hydrogen radicals (H*) may be generated in the plasma generation unit 450 and supplied to the plasma processing region 455 through the penetration pipes 436. Then, the silane (SiH₄) gas meets the hydrogen radicals (H*) in the plasma processing region 455, thereby growing an epitaxial layer of good quality on the substrate 280. In some embodiments, for growth of the epitaxial layer on the substrate, helium may be supplied as an inert gas, for example, at a flux ranging from about 1 slm to about 100 slm and hydrogen (H₂) may be supplied, for example, at a flux ranging from about 1 sccm to about 100 sccm. Further, silane (SiH₄) may be supplied, for example, at a flux ranging from about 1 sccm to about 100 sccm. The pressure of the plasma generating region 450 may be maintained in the range from about 500 Torr to about 900 Torr, more specifically, at 760 Torr.

In some embodiments, the atmospheric pressure plasma generating apparatus may be applied to a process of manufacturing a TFT, LCD, PFD, or photovoltaic cell, as shown in FIG. 6. Specifically, in manufacture of an integrated circuit, the atmospheric pressure plasma generating apparatus may be used to remove from the substrate, a native oxide layer with a thickness of a 10 nm or less formed by reaction between oxygen in atmosphere and a silicon substrate, an insulation layer including an oxide layer chemically grown on the surface of the silicon surface during a manufacturing process, a damaged layer formed on the silicon surface during dry etching, and a thin contaminant layer formed on the silicon surface and the sidewall of a contact hole. The atmospheric pressure plasma generating apparatus may also be used to perform continuous deposition of an epitaxial layer, a low temperature polycrystalline silicon layer, etc. on the surface of the substrate, from which the insulation layer, damaged layer or thin contaminant layer is removed.

Furthermore, the atmospheric pressure plasma generating apparatuses according to the embodiments enable effective generation of atmospheric pressure plasma having high density without arc discharge, thereby increasing the density of reactive radicals. Accordingly, the reaction rate of the plasma with the substrate is increased, thereby improving the growth rate of a thin film. Further, the atmospheric pressure plasma generating apparatuses according to the embodiments enable thin film growth at a lower temperature than conventional techniques.

Although some embodiments have been provided in the present disclosure, it should be understood that these embodiments are given by way of illustration only, and that various modifications, variations, and alterations can be made without departing from the spirit and scope of the present invention, as defined only by the accompanying claims and equivalents thereof. By way of example, such modifications may be applied to a low temperature polysilicon deposition process, a buffer silicon nitride layer process, and the like, in manufacture of LCDs, as shown in FIG. 8. Therefore, those skilled in the art will appreciate that various modifications, additions and substitutions are possible, without departing from the scope and spirit of the inventive concept as disclosed in the accompanying claims.

What is claimed is:

1. An atmospheric pressure plasma generating apparatus comprising:
an upper electrode having an air permeable inner structure;
a lower electrode separated from the upper electrode;
a power source applying voltage to the upper electrode or the lower electrode; and
a plasma generating region placed in a space between the upper electrode and the lower electrode,
wherein the upper electrode serves as a passageway using the air permeable inner structure thereof, through which reaction gas is supplied to the plasma generating region from outside.

2. The atmospheric pressure plasma generating apparatus of claim 1, wherein the upper electrode comprises an electric conductor formed of a porous material and the reaction gas is supplied to the plasma generating region after passing through the upper electrode.

3. The atmospheric pressure plasma generating apparatus of claim 2, wherein the upper electrode comprises at least one selected from among carbon, graphite, copper, and aluminum.

4. The atmospheric pressure plasma generating apparatus of claim 2, wherein the upper electrode comprises a surface coating layer of an insulation material on the electric conductor.

5. The atmospheric pressure plasma generating apparatus of claim 1, wherein the upper electrode has a thickness ranging from 0.01 mm to 100 mm and comprises an air permeable inner structure having a conductive network shape or a grain shape of conductive particles.

6. The atmospheric pressure plasma generating apparatus of claim 1, further comprising:
a dielectric disc having an air permeable structure and attached to a lower surface of the upper electrode adjoining the plasma generating region.

7. The atmospheric pressure plasma generating apparatus of claim 6, wherein the dielectric disc comprises a porous insulation material and has a function of spreading the reaction gas or preventing arc discharge upon generation of plasma.

8. The atmospheric pressure plasma generating apparatus of claim 7, wherein the dielectric disc comprises at least one selected from among zirconium oxide, alumina, silicon carbide, silicon nitride, and quartz.

9. The atmospheric pressure plasma generating apparatus of claim 6, wherein the dielectric disc has a thickness ranging from 0.01 mm to 100 mm, and the air permeable inner structure of the dielectric disc has a conductive network shape or a grain shape of non-conductive particles.

10. The atmospheric pressure plasma generating apparatus of claim 1, wherein the upper electrode is connected at one end thereof to the power source and the lower electrode is connected at one end thereof to ground.

11. The atmospheric pressure plasma generating apparatus of claim 1, wherein the power source applies voltage in the form of unipolar pulses or bipolar pulses.

12. The atmospheric pressure plasma generating apparatus of claim 1, wherein the power source applies RF (radio frequency) voltage in a frequency band of 1 MHz to 500 MHz.

13. The atmospheric pressure plasma generating apparatus of claim 1, wherein the lower electrode is placed below a substrate to be subjected to plasma treatment.

14. The atmospheric pressure plasma generating apparatus of claim 1, wherein the lower electrode is placed above a substrate to be subjected to plasma treatment and has an air permeable inner structure.

15. The atmospheric pressure plasma generating apparatus of claim 14, wherein the lower electrode comprises an electric conductor formed of a porous material.

16. The atmospheric pressure plasma generating apparatus of claim 14, wherein the lower electrode has a function of spreading radicals by allowing the radicals in the plasma generating region to pass through the lower electrode.

17. The atmospheric pressure plasma generating apparatus of claim 14, wherein the lower electrode has a thickness ranging from 0.01 mm to 100 mm and comprises an air permeable inner structure having a conductive network shape or a grain shape of conductive particles.

18. The atmospheric pressure plasma generating apparatus of claim 1, wherein the reaction gas is supplied from outside through at least one process gas supply tube placed above the upper electrode, and comprises at least one selected from the group consisting of vapor (H₂O), oxygen (O₂), nitrogen (N₂), hydrogen (H₂), argon (Ar), helium (H₂), methane (CH₄), ammonia (NH₃), carbon fluoride (CF₄), acetylene (C₂H₂), propane (C₃H₈), silane (SiH₄), disilane (Si₂H₆), dichlorosilane (DCS, SiH₂Cl₂), neo penta silane (NPS), trimethyl aluminum (TMA), bis(tertiary-butylamino) silane (BTBAS), bis(diethylamino) silane (BDEAS), tris(dimethylamino) silane (TDMAS), hexamethyldisiloxane (HMDSO), tetramethylcyclotetra-siloxane (TMCTS), tetraethylorthosilicate (TEOS), hexamethyldisilazane (HMDSN), and tetramethyldisiloxane (TMDSO).

19. The atmospheric pressure plasma generating apparatus of claim 1, further comprising: a gas supply tube through which reaction gas is supplied to the plasma generating region from outside without passing through the upper electrode.

20. An atmospheric pressure plasma generating apparatus comprising:
a plasma generating region,
the plasma generating region comprising:
an upper electrode comprising an air permeable material,
a lower electrode separated from the upper electrode,
a power source applying voltage to the upper electrode or the lower electrode, and
a process gas supply tube placed above the upper electrode to supply reaction gas into the plasma generating region from outside; and
a plasma processing region placed at a lower portion of the apparatus near the plasma generating region and receiving a target substrate.

21. The atmospheric pressure plasma generating apparatus of claim 20, further comprising: a dielectric disc comprising an air permeable material and attached to a lower surface of the upper electrode.

22. The atmospheric pressure plasma generating apparatus of claim 20, wherein the lower electrode comprises an air permeable material.

23. The atmospheric pressure plasma generating apparatus of claim 20, wherein the upper electrode comprises at least one selected from among carbon, graphite, copper, and aluminum.

24. The atmospheric pressure plasma generating apparatus of claim 20, wherein the lower electrode comprises at least one selected from among carbon, graphite, copper, and aluminum.

25. The atmospheric pressure plasma generating apparatus of claim 20, wherein the upper electrode is fabricated by coating a surface of at least one material selected from among carbon, graphite, copper, and aluminum with an insulation material.

26. The atmospheric pressure plasma generating apparatus of claim 20, wherein the lower electrode is fabricated by coating a surface of at least one material selected from among carbon, graphite, copper, and aluminum with an insulation material.

27. The atmospheric pressure plasma generating apparatus of claim 20, wherein the lower electrode comprises:
a conductive plate having plural first through-holes formed therein;
a spreading plate having plural second through-holes corresponding to the plural first through-holes and separated from the conducive plate to face each other, the spreading plate comprising an air permeable material; and
a penetration pipe connecting the first through-holes and the second through-holes.

28. The atmospheric pressure plasma generating apparatus of claim 25, wherein the plasma generating region further comprises a gas supply tube through which a source gas is supplied to a space between the conductive plate and the spreading plate, and radicals of plasma generated in the plasma generating region are supplied to the plasma processing region through the penetration pipe and the source gas supplied through the gas supply tube is supplied to the plasma processing region through the spreading plate of the air permeable material, thereby the radicals and the source gas are independently supplied to the plasma processing region so as not to react with each other.

29. The atmospheric pressure plasma generating apparatus of claim 25, wherein the spreading plate comprises a porous conductive material or a porous insulation material.
